(19) United States
(12) Patent Application Publication
(10) Pub. No.: US 2005/0044030 A1
(43) Pub. Date: Feb. 24, 2005

(54) Order delivery mechanism for use with a trading system

(76) Inventors: Matthew Lockley, Kent (GB); Leonid Shleymovich, Buffalo Grove, IL (US)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/643,656

(22) Filed: Aug. 19, 2003

(51) Int. Cl. G06F 17/60

(52) U.S. Cl. 705/37

(57) ABSTRACT

An order delivery mechanism for use with a trading system is disclosed. The order delivery mechanism is operative to receive an electronic order request and to dispatch that request to a trader located in a market in which the request can be actioned. This provides a direct electronic interface between a trader who is making use of an electronic trading desk and a traditional market that operates in a trading floor (otherwise known as a “pit”). A system embodying the invention can operate in parallel with an existing order delivery electronic system to provide access to a market when the existing system has failed and the market has resorted to trading on a trading floor.

### BACKGROUND TO THE INVENTION

### FIELD OF THE INVENTION

This invention relates to an order delivery mechanism for use with a trading system.

Traditionally, items such as stocks and shares, commodities, etc. were traded using direct verbal communication between traders in a common location. This gives rise to the familiar image of traders in the so-called “pit” exchanging orders, often very volubly and at high speed. In such markets, orders are normally passed by telephone phoned into desks around the side of pit. Then, a ticket is written and a ‘runner’ runs the ticket into the pit. Alternatively, the clerk receiving the order over the telephone may signal the order into the pit.

In Europe, many such trading pits have now been replaced by electronic trading arrangements in which the traders communicate with one another using interlinked computer systems. This has many advantages, not least of which is that one trader can participate in many markets simultaneously, even if they are geographically far apart.

However, in other parts of the world, North America included, trading pits are still in use for some important markets. These markets are not directly accessible to a person trading electronically. Such traders must work through a person on the trading floor as a go-between. Hitherto, the limited ability to communicate to a trader in the pit has resulted in slow and inefficient trading for those acting at a distance. Moreover, trading actions carried out in a non-electronic market are not integrated into the rest of the trader's deals, which are handled by the trader's electronic trading desk.

Moreover, electronic trading systems are reliable, but not infallible. When electronic trading systems fail, a market can revert to conventional pit trading. Effectively, the market becomes a non-automated market. If a client does not have the skills, qualification or geographical location necessary to access the market, trading on the market would be interrupted.

### SUMMARY OF THE INVENTION

An aim of this invention is to provide a system whereby trading in the pit a non-automated market can be better integrated with trading activities on electronic markets.

Therefore, from a first and most general aspect, this invention provides an order delivery mechanism for use with a trading system that is operative to receive an electronic order request and to dispatch that request to a trader located in a market in which the request can be actioned.

From the point of view of the user of the system, the fact that the trade is actually actioned by a person is largely transparent. This means that the user can interact with a conventional trading pit in largely the same way as interaction with an automated market. This can be applied both to a market that has not adopted electronic trading and to a market in which electronic trading systems are not available. An exchange has a floor-based order routing mechanism that routes orders to the pit environment. A system embodying the invention can be used in parallel with an existing routing system as a complementing technology. Thus, when an existing system fails, the system embodying the invention can act as a replacement to get orders to the pit.

The request can be conveyed to the trader in any of several ways. For example, instructions required to make a trade may be presented on a display of a computing device in the possession of the trader. For instance, this may be a small, handheld device that the trader can carry into the trading pit. In this latter case, it is advantageous if the handheld device can exchange data with a server by way of a wireless link. In that way, it is possible to send data to and receive data relating to trading activities to and from the device while trading is taking place. The wireless link may (amongst other possibilities) make use of wireless LAN technology (e.g., according to one of the IEEE 802.11 standards), ad-hoc communication technology (e.g., Bluetooth (r. t. m.)) or wireless telephony (e.g., cellular—GSM or other, or DECT). As an alternative example, apparatus local to the trader may print a paper order that provides the trader with instructions required to make a trade.

An order delivery mechanism embodying the invention may suitably be implemented as a client/server system. In such a system, each server may be in communication with one or more clients. In such embodiments, the server may emulate an exchange-specific adapter to which an electronic trading system can connect. This enables the electronic trading system to interface with the non-automatically traded market, through the system of the invention, as if it were trading with an electronically traded market. Each client is typically apparatus that can present information to and receive information from a market floor trader.

The server may, in some embodiments, send a single trading request to more than one system client. Since the trade will actually be performed by a person, this can help to ensure timely handling of the request in the event that one or more individual traders are not available. The particular clients to which the request will be sent are members of a hunt group of traders that can potentially action the request. In order that the request is not processed by more than one client, in typical embodiments no client can process the request until it has obtained an exclusive lock on the request. The exclusive lock may be requested by one or more clients and allocated by the server to the client associated with the first such request that it receives. To ensure that the request is not lost in the event of a problem associated with the client to which the exclusive lock has been granted, the server may cause the lock to be timed out if the request is not completed within a predetermined period of time.

The invention provides an order routing system that is not tied to an exchange. It can be used to trade anything that can be bought or sold. So, if a provider of a system embodying the invention has a client that happens to have a product that they buy or sell, and there are other parties interested in buying or selling that product, a system embodying the invention can be used to transact that business. Use of embodiments of the invention is not restricted to be an official exchange recognised product.

### BRIEF DESCRIPTION OF THE DRAWINGS

In the drawings:

FIG. 1 as a block diagram of the architecture of a system embodying the invention;

FIG. 2 is a block diagram of a system embodying the invention interacting with an electronic trading system;

FIG. 3 illustrates multiple system servers interacting with a common market;

FIG. 4 illustrates the integration of the system embodying the invention with real-time prices from non-electronic exchanges;

FIG. 5 is a screenshot showing an executing client of a system of the present invention;

FIG. 6 is a screenshot showing a status screen of the client of FIG. 5;

FIG. 7 is a data flow diagram that illustrates flow of messages between a server of the embodiment and an order routing engine;

FIG. 8 is a data flow diagram that illustrates flow of messages between a client and a server of the embodiment; and

FIG. 9 illustrates the data flow within an order locking mechanism optionally implemented in embodiments of the invention.

### DETAILED DESCRIPTION OF THE PREFERRED EMBODIMENT

An embodiment of the invention will now be described in detail, by way of example, and with reference to the accompanying drawings.

Overview

This embodiment of the invention is implemented as a client-server system. It is implemented on two main functional components: an order router (the server) 10; and one or more client devices 12 for receiving and printing orders and entering fill information (the client). Each client connects 12 to the server 10 directly over a TCP/IP network link.

To achieve the aims of the invention in a specific example application, an automated system must implement electronic trading with the specific market of interest, in this case, the Chicago Board of Trade (CBOT). The aim of the embodiment to be described is to supplement the CBOT “Order Direct” exchange-specific adapter (ESA) to provide a full package to cover non-automated trading on the CBOT floor. This allows trading to continue in the event of in the event of an exchange routing failure or if the direct electronic routing system has failed for any reason. To achieve this, the embodiment provides a secondary system, which, to a great extent, mimics the CBOT Order Direct functionality when routing orders to the floor.

The embodiment comprises two principle components:
an order router (system server) 10; and
a client device 12 for receiving and printing orders and entering fill information the (system client).

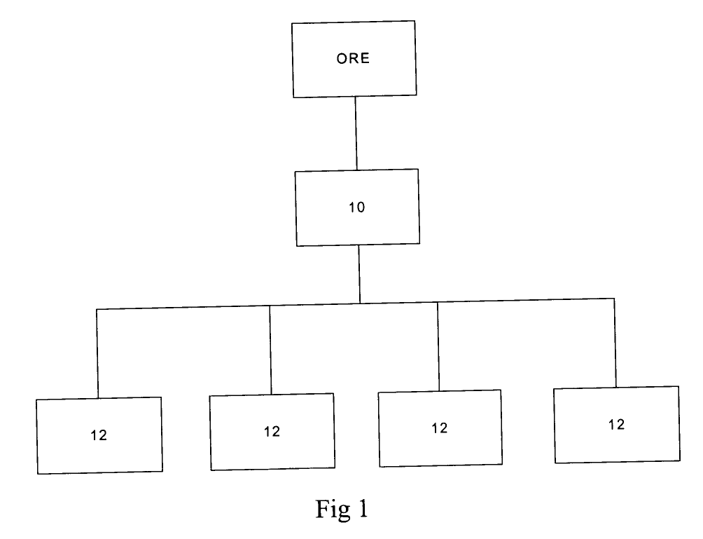

FIG. 1 outlines the basic system architecture.

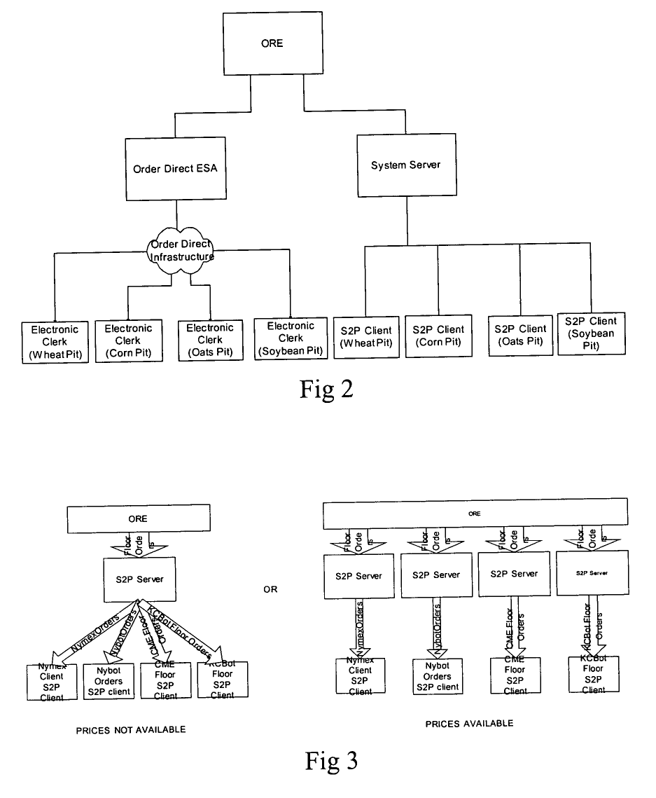

Each system client 12 connects to the system server 10 directly over TCP/IP and communicates by exchange of messages. This particular system is to be combined with the CBOT Order Direct ESA to provide a full package to cover trading on the CBOT floor and allow for failover in the event of an exchange routing failure. So when using the embodiment in conjunction with the Order Direct, the architecture for the CBOT Order Direct exchange is shown in FIG. 2.

In FIG. 2, the bottom row is a row of clients. In principle, these may be operating in different institutions and may be geographically dispersed, however this does not apply in the case of this embodiment. The second-bottom row represents system servers. These are the direct points of contact for the clients.

It is recognised that the embodiment has benefits other than those discussed above. In particular, it is not exchange specific. There is no exchange specific code in the system. It been designed to be open in it's use so that it can be used to different exchanges on the same system.

Due to nature of it connectivity to the system, the system can be used to “mimic” any exchange. Because the external interface is based upon message exchange, the messages have been defined in accordance with a suitable accepted standard. This, the clients do not need to know about the internal organisation of the system and the system need not maintain details about the trading events that it is handling. It is the responsibility of the system client users to actually trade the actual orders correctly and report them correctly. The geographical restriction typically associated with a trading pit is also removed because client can be deployed so long as the machine it is running on can establish a TCP/IP connection with the server. For example, it can be deployed anywhere, a trading desk at a foreign exchange FX firm, or on the floor of an exchange using wireless LANs. The system potentially allows a user to trade markets that do not currently exist. As long as you have an order taker user, the system client and it requires a buy and a sell to be involved this can be used to trade.

The invention does not impose a limit of just one system server for each exchange. It is possible to configure a single exchange for the system that can handle all non-electronic business. Since at its simplest all routing is performed contract it is possible to trade contracts on multiple exchanges trading through a single system exchange. FIG. 3 illustrates this. Embodiments can be used with price feeds for floor-based exchanges around the world.

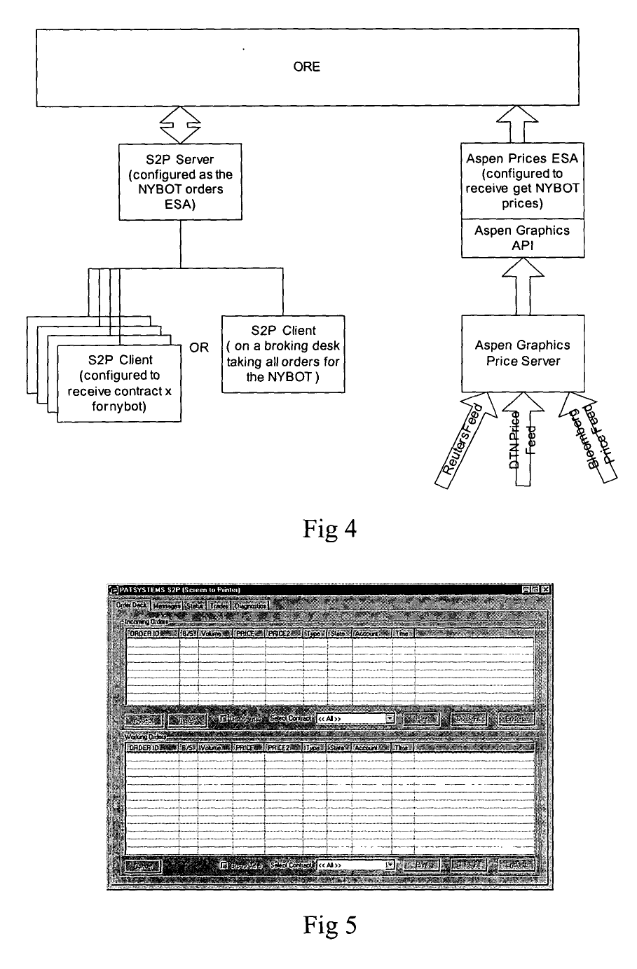

For example, embodiments have been developed to the “Aspen Graphics” API. This API allows the integration of the system with real-time prices from non-electronic exchanges using a third-party price feed such as Reuter, DTN, Bridge and Comstock. The aspen graphics API provides a single interface to request prices from the above price feed providers. This allows the system to request prices for contracts that currently do not have price feeds into a conventional electronic trading system and to provide a fully integrated environment with prices and order routing. FIG. 4 serves as an explanation of this.

With this screen-based mechanism there is no need to produce order tickets to trade in a pit-based environment. If the system client 12 can be placed in the pit environment then there is no need to produce a ticket; everything can be performed in the electronic environment up to the point of matching the order.

Although there is no need for paper using the system client 12 the client and server 10 have apparatus by which tickets can be printed. The client 12 has the ability to print user defined format order tickets from the client to any printer the client PC can see on a windows network. The system server 10 can also print order tickets in a standard format or a user-defined format so a full paper audit trail of all orders/trades that have passed through the system can be generated.

As a result of the system being integrated into the an existing electronic trading system, this gives rise to the benefits of being able to report floor trades automatically to a client's back office system through the back office API. This eliminates any human intervention in the clearing cycle for any non-electronically traded contract.

The System Server

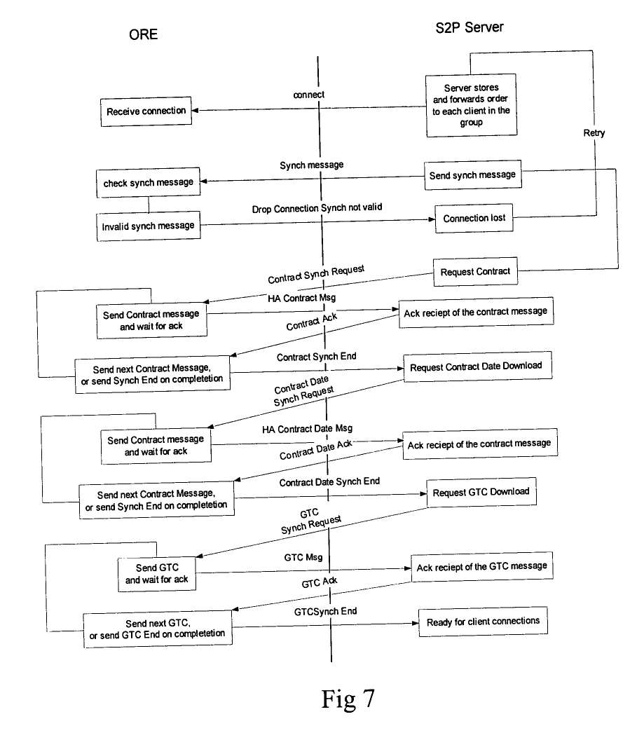

The system server 10 can be likened to an ESA that connects to the order routing engine (ORE) like any other ESA on the electronic trading system. Unlike a conventional ESA, which connects to an exchange, the system server 10 listens for incoming client connections from system clients 12. FIG. 7 is a data flow diagram that illustrates the flow of messages between the server and the ORE upon establishment of a connection.

On receipt of a client connection, the server validates that the connection is a system client 12. Then, from this time on, the server 10 will route orders to the client 12 using a routing table that is configured in a configuration file of the server 10. This routing information allows the server 10 to configure any number of routes from a singe route to a single client up to many routes to many clients. Moreover, the routing information can provide additional detail about the routing. For example, the system server can route by:
contract: e.g. wheat can be routed to client y while corn can be routed to client z.
contract date: e.g. December wheat can be routed to client x while all other wheat orders are routed to client y.
user: e.g. Bob's orders can be routed to client a while everyone else's orders are routed to client b.
Buy or sell: e.g. all buys are routed to client c and all sells are routed to client b.

This give the user a high degree of control over how their orders are routed, and these possible routes can be combined together to give an even greater degree of flexibility. See the following table for examples of how the order routing can be configured.

| CR | CDR | UR | B/S | TP | Description |
|---|---|---|---|---|---|
| TNOTE10 | SEP01 | MATTROUTE | B | MEMPHIS | For TNOTE10 SEP01 all buy orders will be routed to device |
| | | | | | MEMPHIS for users with route id MATTROUTE. |
| TNOTE10 | SEP01 | MATTROUTE | | BOB | For TNOTE10 SEP01 all orders will be routed to device BOB |
| | | | | | or users with route id MATTROUTE |
| TNOTE10 | SEP01 | | B | MEMPHIS | For TNOTE10 SEP01 all buy orders will be routed to device |
| | | | | | MEMPHIS. |
| TNOTE10 | SEP01 | | | BOB | For TNOTE10 SEP01 all orders will be routed to device BOB. |
| TNOTE10 | | MATTROUTE | B | MEMPHIS | For the TNOTE10 contract all buy orders will be routed to |
| | | | | | device MEMPHIS for users with route id MATTROUTE |
| TNOTE10 | | | B | TED | For the TNOTE10 contract all buy orders will be routed to |
| | | | | | device TED |
| TNOTE10 | | | | FRED | For the TNOTE10 contract all orders will be routed to device |
| | | | | | FRED |

In the table:
CR = Contract Route, CDR = Contract Date Route, UR = User Route, B/S = Buy or Sell Route, TP = Name of system client machine

Also the system server can optionally be configured to print order tickets for all orders that it receives so that there is an audit trail in place in case there are any problems.

In many embodiments, each server will handle orders for just one exchange. However, this can be extended such that the server can route orders between multiple clients and multiple exchanges.

The System Client

The system client has been implemented as a GUI application. This means that it will run on a standard PC as well as handheld devices. This allows the client to be deployed in the pit environment as well as on a desktop allow maximum flexibility. An example GUI of the client is shown in FIG. 5.

The system client has also been designed without exchange-specific functionality so that it is not tied to any exchange. This whole system uses the contract names of the trading system with which it is associated. That is to say, internal trading system names and not the exchange names for contracts are used, therefore there is no exchange specific information passed from through the system. This enables any tradable entity that can be configured into the electronic trading system to be traded through the system client.

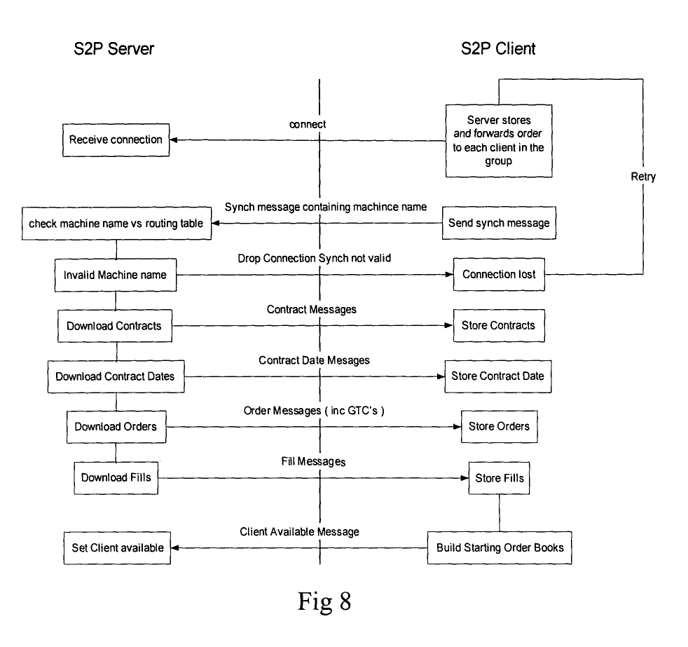

Each client operates by interacting with the server. FIG. 8 illustrates the flow of data that can arise between the server and each client. The main functional capabilities of the system client are as follows:

Accept or reject incoming orders: The order deck screen is split into windows, the incoming window being at the top of the screen where new orders/amendments and order cancellations appear. The broker/clerk using the client can either accept or reject the incoming request. If they accept the order, this will send an order acknowledgement back to the electronic trading system to confirm the order as working. If the broker/clerk rejects the order, a reject reason window will appear where they can select the reason for the rejection. From this screen the broker/clerk will also be able to either quick fill or endorse fill. (See below)

Manage (cancel and fill) Working Orders: The second window on this screen is the working orders screen. This is where orders will reside until they are filled or cancelled. This part of the screen lists the latest information about the currently working orders. From this, the user can cancel and fill orders.

Issue Quick Fills or Endorsed Fills: Quick fills—a quick fill can be used in time of high market activity to fill orders this allows the broker/clerk to enter just price and volume information for a fill without having to enter the opposite broker information. This allows faster fill notification through to the electronic trading system. These fills can be endorsed at a later date. Endorsed fill—an endorsed fill is a fill where all qualifying information as been entered. The qualifying information is “price”, “volume”, “opposite broker” and “opposite firm”.

Reverse and re-issue fills to correct erroneous fill entry: Reversing a fill is used when there has been an error in fill entry. Since fill entry is a manual process. it is prone to human error. This gives the clerk/broker a chance to verify the information entered, and correct it if necessary. When a reverse fill is entered it sends a cancelling fill, which is a fill with a negative volume to cancel out the originally entered fill.

Re-issuing a fill takes this process once step further. This allows the broker/clerk to enter new fill details for a previously entered fill, this can be used in circumstances where a fill has been entered with, for example, an incorrect price. The re-issue reverses the original fill and sends through a new fill to replace it.

Print order tickets: The client has the ability to print actual trading tickets when it is installed in a location from which it can access a printer. The printer preferably is one that that has the ability to print on to multi-part continuous form order ticket media. This printer does not have to be physically attached to the client computer. As long as it can be seen using the printer support services of the operating system under which the client is running then the client has the ability to send an order to it.

User definable order ticket printer: The client's ticket printing functionality has the ability to print different format tickets. The client's paper tickets tend to be specific to the firm that produces them. Therefore, the client has the ability for the user to define how the ticket is to be printed so that all of the data on the ticket is correctly positioned on the ticket. This is done with the use of ticket format templates which allow the format of ticket to be printed to be defined.

The printing of order tickets allow the recovery to the last known state of an order in case of shutdown or application failure: If the application is shutdown or fails, the client will recover to its last known state prior to the application failure.

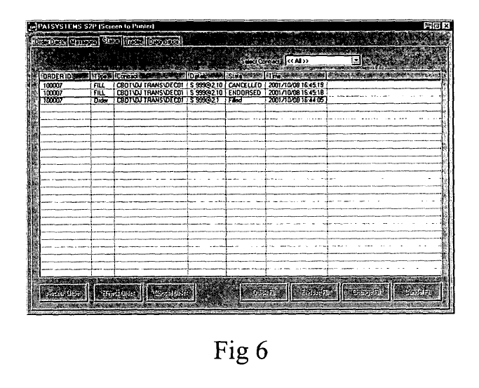

Ability to view order history for the full trading day: The client maintains the entire order book for the trading day so the user can at any time interrogate order status from earlier in the day. This includes filled/rejected and working orders. This is possible through the status screen, shown in FIG. 6.

Ability to send messages to other components: The client has the ability to send messages directly to the other components of the electronic trading system, such as the administrator. Through the messages screen a broker/clerk can send alert messages to a system and risk Administration GUI.

Description of routing in a typical embodiment of the invention was described above. In some cases, is a requirement that the system should allow the sending of orders to multiple groups of clients. This can be useful, for example, in a broking desk situation where all stations on the desk are not occupied at the same time. Thus, anyone who is at the desk will be able to pick up and action the order.

This requires “hunt groups” to be set up where when an order is submitted to the system server, it looks up the list of clients the order should be sent to and subsequently sends the order to each of the clients. However, steps must be taken to ensure that the order is only actually processed by one client. To implement this, an order locking mechanism is added to the system to prevent more than one client working on an order at any one time.

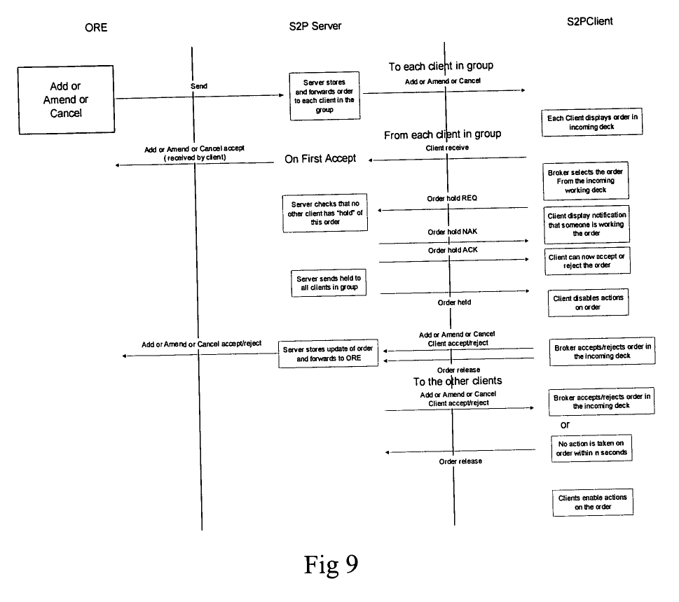

To implement the order locking mechanism (described with reference to FIG. 9), the client when an order is selected must send to the server a request to lock the order. (This will be done in response to an action by a trader.) If this client is the first to send the request to lock the order, it will be granted by the server. All other clients in the hunt group will be sent an order lock notification. At this point, each client must disable any processing on that order and display a message on the client screen to notify that the order is being worked.

If two or more clients attempt to lock the order at approximately the same time, whichever client gets the request to lock the order first will be notified that it has the file. The other client(s) will be sent a message rejecting the request to lock. At this time, they must disable updates to that order to prevent further changes to the order.

To prevent an occurrence of a user locking an order for update then not making any changes to the order, after a pre-defined period of time the system server will release the lock on the order by sending a release notification to all the clients in the hunt group. At this point the client that had the lock must release the lock on the order and all other clients must return the order to a released state.

Alternatively, when the client with the lock has finished with the order (either by selecting another order or performing an action on the order such as accepting the order) the locking client will send a release lock request to the server to notify that it has completed working on the order. The system server will then send a release notification to the other clients in the hunt group (plus any order updates, to the other clients) so that they are kept in synchronisation with one another

1. An order delivery mechanism for use with a trading system operative to receive an electronic order request and to dispatch that request to a trader located in a market in which the request can be actioned.

2. An order delivery mechanism according to claim 1 in which apparatus local to the trader is operative to print a paper order that provides the trader with instructions required to make a trade.

3. An order delivery mechanism according to claim 1 further comprising computing a device having a display upon which instructions required to make a trade can be presented to a trader.

4. An order delivery mechanism according to claim 3 in which the device is a handheld computing device that the trader can carry into the trading pit.

5. An order delivery mechanism according to claim 4 in which the handheld device can exchange data with a server by way of a wireless link.

6. An order delivery mechanism system according to claim 5 in which the wireless link makes use of one or more of wireless LAN technology, ad-hoc communication technology or wireless telephony.

7. An order delivery mechanism according to claim 1 implemented as a client/server system.

8. An order delivery mechanism according to claim 7 each server may be in communication with one or more clients.

9. An order delivery mechanism according to claim 7 in which the server emulates an exchange-specific adapter to which an electronic trading system can connect.

10. An order delivery mechanism according to claim 7 in which a client includes apparatus that can present information to and receive information from a market floor trader.

11. An order delivery mechanism according to claim 7 in which a client includes a software program executing on a handheld computing device.

12. An order delivery mechanism according to claim 7 in which the server operates to send one trading requests to a plurality of clients.

13. An order delivery mechanism according to claim 12 in which the plurality of clients to which the request will be sent are members of a hunt group of traders that can potentially action the request.

14. An order delivery mechanism according to claim 12 in which a client does not process the request until it has obtained an exclusive lock on the request.

15. An order delivery mechanism to claim 13 in which the exclusive lock is requested by a client and allocated by the server to the client associated with the first such request that it receives.

16. An order delivery mechanism according to claim 13 in which the exclusive lock is timed out if the request is not completed within a predetermined period of time.
